(19) United States
(12) Patent Application Publication
(10) Pub. No.: US 2025/0383618 A1
(43) Pub. Date: Dec. 18, 2025

(54) SHEET CONVEYANCE APPARATUS AND IMAGE FORMING APPARATUS

(71) Applicant: CANON KABUSHIKI KAISHA, Tokyo (JP)

(72) Inventors: YUTA SUZUKI, Ibaraki (JP); YUKINOJO TODA, Saitama (JP); IKU SHIMIZU, Chiba (JP); YUYA HAMAJI, Chiba (JP); TAKURO YOSHIKAWA, Chiba (JP)

(21) Appl. No.: 19/226,330

(22) Filed: Jun. 3, 2025

(30) Foreign Application Priority Data
Jun. 14, 2024 (JP) 2024-096541

(51) Int. Cl. G03G 15/00

(52) U.S. Cl. CPC G03G 15/6564; G03G 2215/00599; G03G 2215/00679

(57) ABSTRACT

A sheet conveyance apparatus includes a registration roller pair, a driving motor, a transmission mechanism, and a control unit. The control unit performs a process of reducing backlash of the transmission mechanism. The control unit obtains, before performing the process of reducing backlash, a target rotation speed of the driving motor at which the sheet is conveyed by the registration roller pair after the process of reducing backlash. In the process of reducing backlash, the control unit accelerates the driving motor to the target rotation speed and subsequently reduces rotation speed of the driving motor from the target rotation speed to stop the driving motor in a same manner as that after the sheet is conveyed by the registration roller pair after the process of reducing backlash, the control unit reduces the rotation speed of the driving motor from the target rotation speed to stop the driving motor.

### BACKGROUND

### Field of the Technology

The present disclosure relates to a sheet conveyance apparatus that conveys sheets, and an image forming apparatus that forms images on sheets by using the sheet conveyance apparatus.

### Description of the Related Art

Conventionally, an image forming apparatus synchronizes an image forming timing and a rotation start timing of a registration roller pair that supplies a sheet, with each other; and thereby sets a leading-edge registration value to a desired value. The leading-edge registration value represents the distance between the leading edge of the sheet and the leading edge of the image. In such a configuration, a driving mechanism that includes a gear and a timing belt disposed between a driving motor, which is a driving source, and a driving gear of the registration roller pair may have a backlash in the rotation. In a case where the second and the following sheets are conveyed after a print job is started, when the driving motor stops after sending a preceding sheet, the backlash and the belt tension are stable.

However, before the first sheet is conveyed in the print job, the backlash may occur between gears and the belt tension may change because a roller may rotate, for example, in a jam handling or in replacing a component in the main body. In this case, a time lag may occur in a period of time from when the rotation of the driving motor is started, until when the rotation of the registration roller pair is started. As a result, the timing at which the sheet reaches the image forming unit may be delayed. As countermeasures, Japanese Patent Laid-Open No. H04-66447 proposes an image forming apparatus that performs control for reducing the backlash. Specifically, the image forming apparatus reduces the backlash by rotating the driving motor for a predetermined time and then stopping the driving motor before the leading edge of the first sheet reaches the registration roller pair.

However, Japanese Patent Laid-Open No. H04-66447 fails to refer to the speed for which the control is performed for reducing the backlash in the image forming apparatus.

### SUMMARY

The present disclosure is directed to provide a sheet conveyance apparatus and an image forming apparatus that can reduce the difference of backlash of the drive train.

According to a first aspect of the present disclosure, a sheet conveyance apparatus includes a registration roller pair including a first roller and a second roller configured to contact each other and form a nip portion, the registration roller pair being configured to convey a sheet by rotating after the sheet is abutted against the registration roller pair in a state where the registration roller pair is stopped, a driving motor configured to rotationally drive the first roller, a transmission mechanism including an endless member and configured to transmit power of the driving motor to the first roller via the endless member, and a control unit configured to perform a process of reducing backlash of the transmission mechanism by driving and stopping the driving motor before abutting the sheet against the registration roller pair. The control unit is configured to obtain, before performing the process of reducing backlash, a target rotation speed of the driving motor at which the sheet is conveyed by the registration roller pair after the process of reducing backlash. In the process of reducing backlash, the control unit is configured to accelerate the driving motor to the target rotation speed and subsequently reduce rotation speed of the driving motor from the target rotation speed to stop the driving motor in a same manner as that after the sheet is conveyed by the registration roller pair after the process of reducing backlash, the control unit reduces the rotation speed of the driving motor from the target rotation speed to stop the driving motor.

According to a second aspect of the present disclosure, an image forming apparatus includes the sheet conveyance apparatus, and an image forming unit configured to form an image on a sheet at an image forming position. The control unit is configured to control the driving motor such that the sheet is abutted against the registration roller pair in a state where the registration roller pair is stopped, and subsequently conveyed to the image forming position at an image forming timing.

Features of the present disclosure will become apparent from the following description of embodiments with reference to the attached drawings. The following description of embodiments are described by way of example.

### BRIEF DESCRIPTION OF THE DRAWINGS

FIG. 1 is a cross-sectional view illustrating a state where a right-door unit is closed in an image forming apparatus of a first embodiment.

FIG. 2 is a cross-sectional view illustrating a state where the right-door unit is opened in the image forming apparatus of the first embodiment.

FIG. 3 is a front view illustrating a driving mechanism of the first embodiment.

FIG. 4 is a block diagram illustrating a control system of the image forming apparatus of the first embodiment.

FIG. 5 is a flowchart illustrating a procedure of a process of reducing backlash of the image forming apparatus of the first embodiment.

FIG. 6 is a time chart illustrating the rotation speed of a registration driving motor obtained in the execution of a process of reducing backlash of the image forming apparatus of the first embodiment.

FIG. 7 is a time chart illustrating the rotation speed of a registration driving motor obtained in the execution of a process of reducing backlash of an image forming apparatus of a second embodiment.

FIG. 8 is a diagram illustrating vector control of a registration driving motor of the second embodiment.

FIG. 9 is a block diagram illustrating control functions of a motor control portion of the second embodiment.

### DESCRIPTION OF THE EMBODIMENTS

### First Embodiment

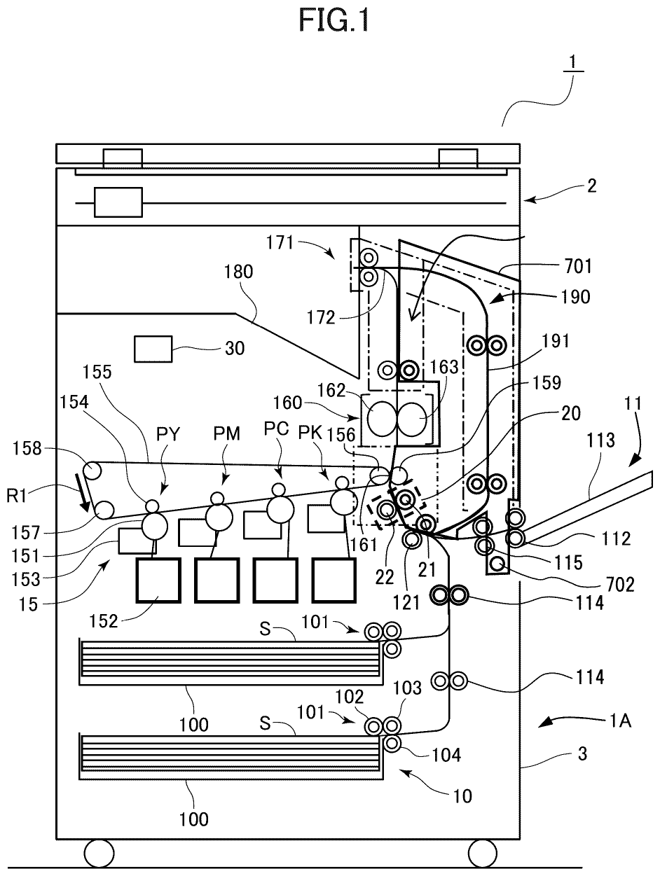

Hereinafter, a first embodiment of the present disclosure will be described in detail with reference to FIGS. 1 to 6. First, a schematic configuration of an image forming apparatus 1 of the present embodiment will be described with reference to FIG. 1. The scope of the present disclosure is not intended to be limited to the size, material, shape, relative position, and the like of components of the image forming apparatus 1, unless otherwise specified.

### Image Forming Apparatus

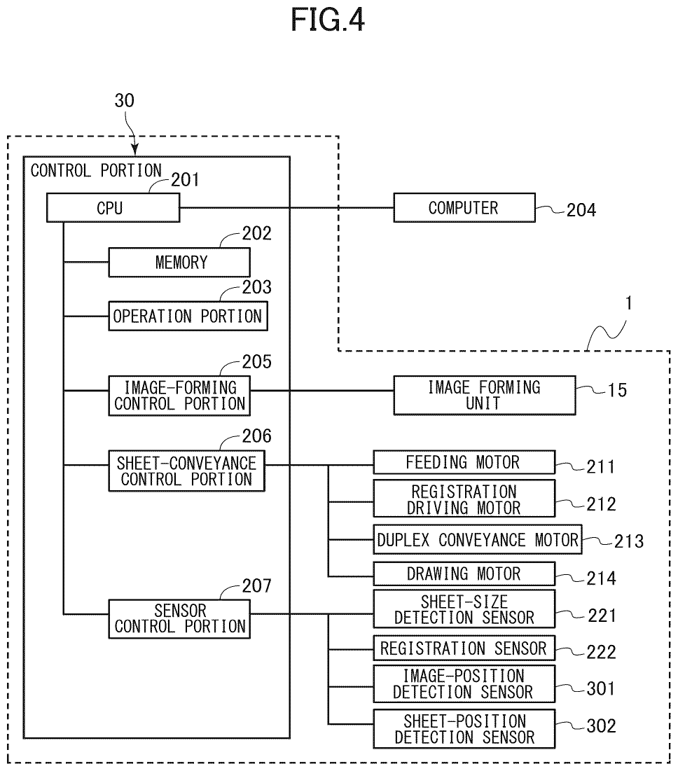

FIG. 1 is a schematic diagram of the image forming apparatus 1 of the present embodiment. The image forming apparatus 1 forms an image on a sheet, used as a recording medium, in accordance with image information sent from an external device, such as a computer 204 (see FIG. 4), or read from a document. The sheet used as the recording medium may be of a variety of sheets having different materials and sizes. For example, the sheet may be a paper sheet, such as a thick paper sheet, a regular paper sheet, or a thin paper sheet having a corresponding grammage, an envelope, a plastic film used for overhead projectors, or a cloth sheet.

The image forming apparatus 1 includes an apparatus body 1A that accommodates an image forming unit 15 that forms an image on a sheet S, and an image reading apparatus 2 that is disposed above the apparatus body 1A and that reads image information from a document. The image forming unit 15 is an intermediate-transfer electrophotographic unit which includes four image forming stations PY, PM, PC, and PK, an intermediate transfer belt 155, and a fixing apparatus 160. The image forming stations PY, PM, PC, and PK correspond to yellow, magenta, cyan, and black, respectively. The image forming unit 15 forms an image on the sheet S at a below-described secondary transfer portion 161 that is one example of an image forming position.

Each of the image forming stations PY to PK forms a toner image on the surface of a photosensitive drum 151 by performing the electrophotographic process. The photosensitive drum 151 is an image bearing member. Since the image forming stations PY to PK have configurations identical to each other except for the color of toner, the configuration of the image forming station PY for yellow will be described as a representative example. If the formation of a toner image is requested to the image forming station PY, the photosensitive drum 151 that serves as a photosensitive member is rotationally driven, and a charging apparatus uniformly charges the surface of the photosensitive drum 151. An exposure apparatus 152 disposed below the photosensitive drum 151 forms an electrostatic latent image on the photosensitive drum 151 by exposing the surface of the photosensitive drum 151, by emitting a laser beam to the photosensitive drum 151 in accordance with image information. A developing apparatus 153 supplies charged toner particles to the photosensitive drum 151, and thereby develops the electrostatic latent image, formed on the photosensitive drum 151, into a toner image.

Toner images having corresponding colors and formed on the respective photosensitive drums 151 in the image forming stations PY to PK are eventually transferred to the sheet S via an intermediate transfer belt 155 and a secondary transfer roller 159. First, a toner image borne by a corresponding photosensitive drum 151 is primary-transferred to the intermediate transfer belt 155 by a primary transfer roller 154. Sticking substance, such as toner, left on the photosensitive drum 151 is removed by a cleaning apparatus disposed in a corresponding one of the image forming stations PY to PK.

The intermediate transfer belt 155 that serves as an intermediate transfer member is wound around a secondary transfer inner roller 156, a tension roller 157, and a stretching roller 158; and is driven and rotated in an R1 direction in FIG. 1. The toner image borne by the intermediate transfer belt 155 is secondary-transferred onto the sheet S at the secondary transfer portion 161 formed between the secondary transfer roller 159 and the intermediate transfer belt 155. The secondary transfer roller 159 faces the secondary transfer inner roller 156. Sticking substance, such as toner, left on the intermediate transfer belt 155 is removed by a belt cleaning apparatus.

The sheet S onto which the toner image has been transferred is delivered to the fixing apparatus 160. The fixing apparatus 160 that serves as a fixing unit of the present embodiment includes a fixing roller 162 that serves as a rotary member that conveys the sheet S, a pressing roller 163 that, together with the fixing roller 162, nips the sheet S, and a heat source (not illustrated), such as a halogen lamp, that heats the toner image formed on the sheet. While conveying the sheet S, the fixing apparatus 160 melts the toner by applying heat and pressure to the toner image. After that, the toner is solidified, and the toner image is fixed to the sheet S.

In the present embodiment, the image forming apparatus 1 is one example of a sheet conveyance apparatus. Hereinafter, a configuration of the image forming apparatus 1 for conveying the sheet S will be described. In parallel with the above-described image forming process, the sheet S is fed, one by one, from a cassette feeding portion 10 or a manual feeding portion 11 toward the image forming unit 15. The cassette feeding portion 10 includes two feeding cassettes 100 disposed in the apparatus body 1A in an up and down direction, and feeding units 101 for feeding sheets S from corresponding feeding cassettes 100. Each of the feeding cassettes 100 stores the sheets. Each of the feeding units 101 includes a pickup roller 102, a feeding roller 103, and a separation roller 104. In a case where the sheet S is fed from the feeding cassette 100 for forming an image, a control portion 30 sends a print signal, so that the sheet S stored in the feeding cassette 100 is fed by the pickup roller 102. After that, the sheet S is fed, one by one, to a conveyance path by a roller pair constituted by the feeding roller 103 and the separation roller 104. The sheet S fed is conveyed by a drawing roller pair 114 and a pre-registration roller pair (hereinafter referred to as a pre-registration roller pair 121). The sheet S is further conveyed toward a registration roller pair (hereinafter referred to as a registration roller pair 20) disposed downstream of the pre-registration roller pair 121 in the sheet conveyance direction.

The manual feeding portion 11 includes a manual feeding tray 113 and a feeding unit 112. The manual feeding tray 113 is a tray on which the sheet S is stacked by a user on the outside of a casing 3 of the apparatus body 1A. The feeding unit 112 feeds the sheet S from the manual feeding tray 113. In a case where the sheet S is fed from the manual feeding tray 113 for forming an image, the control portion 30 sends a print signal, so that the sheet S stored in the manual feeding tray 113 is fed by a pickup roller. After that, the sheet S is fed, one by one, to a conveyance path by a roller pair constituted by a feeding roller and a separation roller, and the sheet fed is conveyed toward the registration roller pair 20 by a drawing roller pair 115 and the pre-registration roller pair 121.

In a case where the sheet S is abutted against the nip portion of the registration roller pair 20 in a state where the registration roller pair 20 is stopped, the pre-registration roller pair 121 pushes the sheet S into the nip portion, so that the sheet S is bent between the pre-registration roller pair 121 and the registration roller pair 20. As a result, the direction of the sheet S is corrected so that the leading edge of the sheet is aligned. In this state, the registration roller pair 20 is rotated, so that the sheet S is conveyed, while the skew of the sheet S is corrected, to the secondary transfer portion 161 that is one example of an image forming position of the image forming unit 15.

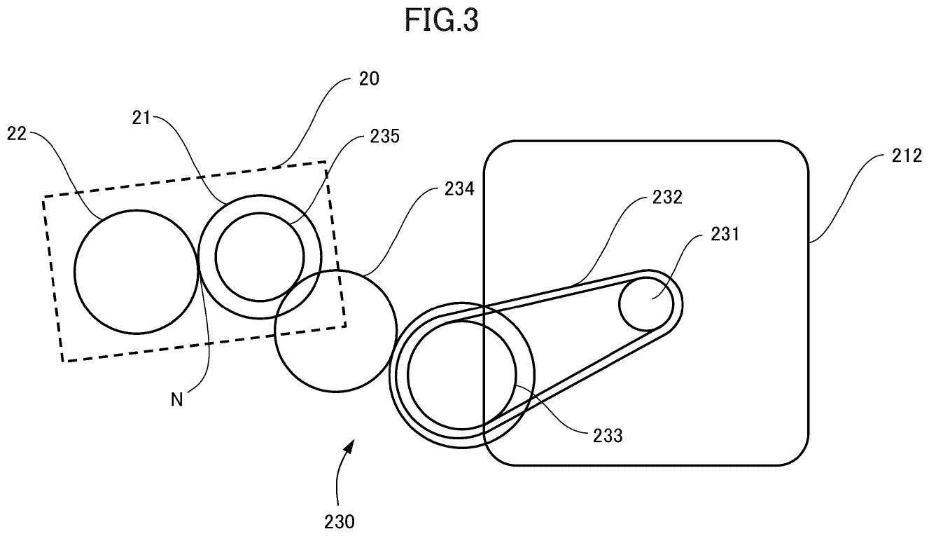

The registration roller pair 20 is one example of a registration roller pair, and includes a driving roller 21 and a driven roller 22. The driving roller 21 is one example of a first roller, and the driven roller 22 is one example of a second roller. The driving roller 21 and the driven roller 22 are in contact with each other, and form a nip portion N. The sheet S is abutted against the registration roller pair 20 in a state where the registration roller pair 20 is stopped, and after that, the registration roller pair 20 is rotated and conveys the sheet S. The registration roller pair 20 is positioned upstream of the secondary transfer portion 161 in the sheet conveyance direction along the vertical direction, and conveys the sheet S to the secondary transfer portion 161 while nipping the sheet S in the nip portion N (see FIG. 3). In the present embodiment, the axis direction of the driving roller 21 is a sheet width direction that intersects the sheet conveyance direction.

The sheet S passes through the secondary transfer portion 161 and the fixing apparatus 160, so that an image is formed on the sheet. After that, the sheet S is conveyed to a discharging roller 171. The discharging roller 171 discharges the sheet S, on which an image has been formed; and stacks the sheet S on a discharging tray 180 disposed in an upper portion of the apparatus body 1A. Note that in the present embodiment, a so-called in-body discharging configuration is used. In the in-body discharging configuration, an in-body discharging space (i.e., a space formed above the discharging tray 180) for stacking the sheet S is formed between the apparatus body 1A and the image reading apparatus 2 in the vertical direction.

In the double-side printing, the discharging roller 171 conveys the sheet S on which an image is formed on a first side. In this case, when the trailing edge of the sheet S has passed through a branch portion 172, the discharging roller 171 switch-backs the sheet S by reversing the conveyance direction. With this operation, the sheet S is delivered to a duplex conveyance portion 190, and is conveyed toward the pre-registration roller pair 121 through a duplex conveyance path 191, by a reconveyance roller pair of the duplex conveyance portion 190. The sheet S is conveyed to the registration roller pair 20 through the pre-registration roller pair 121, and the skew of the sheet S is corrected again. After that, the sheet S passes through the secondary transfer portion 161 and the fixing apparatus 160, so that an image is formed on a second side of the sheet S. Then, the sheet S is discharged by the discharging roller 171, and is stacked on the discharging tray 180.

Note that in the above-described configuration, a direct-transfer electrophotographic unit, or an ink-jet or offset-printing image forming unit may be used as the image forming unit 15. In addition, although a full-color electrophotographic copying machine having a plurality of photosensitive drums is used in the present embodiment, the present disclosure is not limited to this. For example, a monochrome or monocolor copying machine or printer having a single photosensitive drum may be used.

### Opening/Closing Mechanism of Apparatus Body

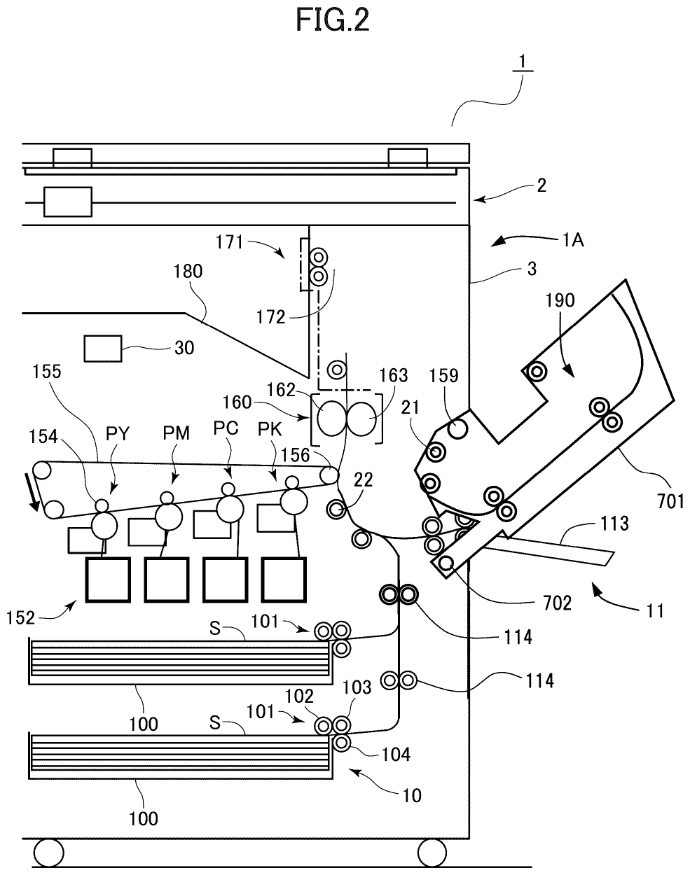

Next, an opening/closing mechanism of a right-side portion of the apparatus body 1A, that is, an opening/closing mechanism of a side portion in which the manual feeding portion 11 is disposed will be described with reference to FIG. 2. FIG. 2 is a cross-sectional view illustrating a state where a right-door unit 701 is opened. As illustrated in FIG. 2, the apparatus body 1A includes the casing 3 and the right-door unit 701. The casing 3 is one example of a fixed-side unit, and the right-door unit 701 is one example of an opened-and-closed-side unit. The casing 3 is opened and closed by right-door unit 701 pivoting with respect to the casing 3 at the right-side portion of the apparatus body 1A.

In the present embodiment, part of the sheet conveyance unit is disposed in the right-door unit 701. Thus, in a case where the sheet S is stuck in the apparatus body for example, the apparatus body 1A can be opened by pivoting the right-door unit 701 on a pivot shaft 702. That is, the right-door unit 701 is opened and closed by pivoting the right-door unit 701 with respect to the casing 3, on the pivot shaft 702 in the right and left direction. The pivot shaft 702 is disposed in the axis direction of the driving roller 21 that is the sheet width direction. For example, the pivot shaft 702 is disposed in the vicinity of a position directly below the feeding unit 112 of the manual feeding tray 113. However, the pivot shaft 702 may not be disposed in the vicinity of the position directly below the feeding unit 112. For example, the pivot shaft 702 may be disposed in the vicinity of a position directly above the feeding unit 112. In the present embodiment, the right-door unit 701 is opened and closed by pivoting the right-door unit 701 on the pivot shaft 702. However, the present disclosure is not limited to this. For example, the right-door unit 701 may be opened and closed by sliding or turning the right-door unit 701.

For making it possible to take out the sheet S without tearing the sheet S when the right-door unit 701 is opened, one roller of a roller pair, such as the driving roller 21, is held by the right-door unit 701. Thus, the rollers of the roller pair can be separated from each other. Thus, the right-door unit 701 supports the driving roller 21, the secondary transfer roller 159, the duplex conveyance portion 190, and the like. In addition, the casing 3 supports the driven roller 22, the secondary transfer inner roller 156, the fixing apparatus 160, and the like. In this configuration, the driving roller 21 and the driven roller 22 are in contact with each other in a case where the casing 3 is closed by the right-door unit 701, and are separated from each other in a case where the casing 3 is opened by the right-door unit 701.

### Driving Mechanism of Registration Roller Pair

Next, with reference to FIG. 3, a driving mechanism for driving and rotating the registration roller pair 20 will be described. FIG. 3 is a front view illustrating a driving mechanism for the driving roller 21 in a state where the right-door unit 701 is closed. As illustrated in FIG. 3, the image forming apparatus 1 includes a registration driving motor 212 that is one example of a driving motor, and a transmission mechanism 230 that drives and rotates the driving roller 21 by transmitting the power of the registration driving motor 212 to the driving roller 21. The transmission mechanism 230 includes a motor pulley 231 disposed on a rotation shaft of the registration driving motor 212, a timing belt 232, a gear pulley 233, and an idler gear 234. The driving force is transmitted from the motor pulley 231 attached to the registration driving motor 212, to the gear pulley 233 via the timing belt 232, and to a registration driving gear 235 via the idler gear 234. The registration driving gear 235 is attached to an end portion of the driving roller 21. The timing belt 232 is one example of an endless member, and is a toothed belt made of an elastic material. Although the timing belt 232 that is a toothed belt is used in the present embodiment, as the endless member, the present disclosure is not limited to this. For example, a toothless belt, a chain, or the like may be used as the endless member.

The registration driving motor 212 and the transmission mechanism 230 are supported by the casing 3, and the position of the registration driving motor 212 and the transmission mechanism 230 is fixed regardless of opening and closing the right-door unit 701. In contrast, as illustrated in FIG. 2, the driving roller 21 is moved in accordance with opening and closing of the right-door unit 701. Thus, the driving roller 21 and the transmission mechanism 230 are connected to each other in a case where the casing 3 is closed by the right-door unit 701, and are disconnected from each other in a case where the casing 3 is opened by the right-door unit 701. That is, when the right-door unit 701 is opened, the registration driving gear 235 and the idler gear 234 are separated from each other. Thus, when the first sheet S is conveyed after the right-door unit 701 is opened and closed, the backlash may occur between gears or between a gear and the belt. Note that in the present embodiment, the description has been made for the case where the driving roller 21 is supported by the right-door unit 701 that pivots. However, the present disclosure is not limited to this. For example, the driving roller 21 may be supported by the casing 3 so that the driving roller 21 and the driven roller 22 are in contact with each other regardless of opening and closing of the right-door unit 701. Even in such a configuration, the backlash may occur when a jammed sheet left in the apparatus body 1A is handled. Thus, in the present embodiment, the process of reducing backlash is performed before the first sheet S is conveyed in an image forming job.

### Control System

Next, the control portion that controls function components of the image forming apparatus 1 will be described. FIG. 4 is a block diagram illustrating a control system of the image forming apparatus 1. The control portion 30 includes function portions including a CPU (central processing unit) 201, a memory 202, an operation portion 203, an image-forming control portion 205, a sheet-conveyance control portion 206, and a sensor control portion 207. Note that the control portion 30 may receive various types of information on the sheet S used for printing, via a computer 204 connected to the control portion 30 via a network.

The CPU 201 achieves various processes performed by the image forming apparatus 1, by executing a predetermined program. The memory 202 may include a RAM (random access memory) and a ROM (read only memory), and stores various programs and data in a predetermined storage area. The operation portion 203 accepts various types of information on the sheet S (e.g., size information, grammage information, and information on surface property) used by a user for printing, and various operations, such as an operation for executing printing and an operation for stopping the printing, performed by a user.

The image-forming control portion 205 sends an instruction to the image forming unit 15 that includes the exposure apparatus 152, and controls the image formation. The sheet-conveyance control portion 206 sends an instruction to a feeding motor 211, the registration driving motor 212, a duplex conveyance motor 213, a drawing motor 214, and the like; and controls the conveyance of the sheet S. The feeding motor 211 drives the feeding unit 101. The registration driving motor 212 drives the registration roller pair 20. The duplex conveyance motor 213 drives the reconveyance roller pair and the like.

The sensor control portion 207 controls the start or stop of the detection performed by a sheet-size detection sensor 221, a registration sensor 222, an image-position detection sensor 301, a sheet-position detection sensor 302, and the like; and accepts the detection result from these sensors. The sheet-size detection sensor 221 and the registration sensor 222 are disposed upstream of the registration roller pair 20 in the sheet conveyance direction.

### Process of Reducing Backlash

In recent years, it has been required to achieve an image forming apparatus that can form images on a variety of sheets including sheets with a larger grammage and sheets (coated sheets) on which surface a coating is applied. Since such sheets require a larger amount of heat for fixing the toner, the sheets are conveyed, with the speed of the image forming unit and each conveyance roller being set to a lower speed than that for sheets with a smaller grammage. That is, a single image forming apparatus may have a plurality of conveyance speeds corresponding to the respective types of sheets on which images are to be formed.

However, Japanese Patent Laid-Open No. H04-66447 fails to refer to the speed for which the control is performed for reducing the backlash in the image forming apparatus. The driving motor vibrates when stopped after the rotation, and the amount of vibration varies depending on the individual difference of the motor and the driving speed. In addition, depending on the amount of vibration, the amount of reduction of the backlash between gears and the belt tension change. Thus, in the image forming apparatus that changes the conveyance speed in accordance with the type of sheets, if a conveyance speed in a sheet passing job and a speed obtained when the driving motor is rotated for reducing the backlash before the first sheet is passed in the sheet passing job are different from each other, the following problem may occur. That is, in this case, the responsivity from when the registration roller pair is stopped, until when the rotation of the registration roller pair is started for conveying a sheet varies. As a result, the timing at which each sheet reaches the image forming unit does not become constant, so that the leading-edge registration value may vary.

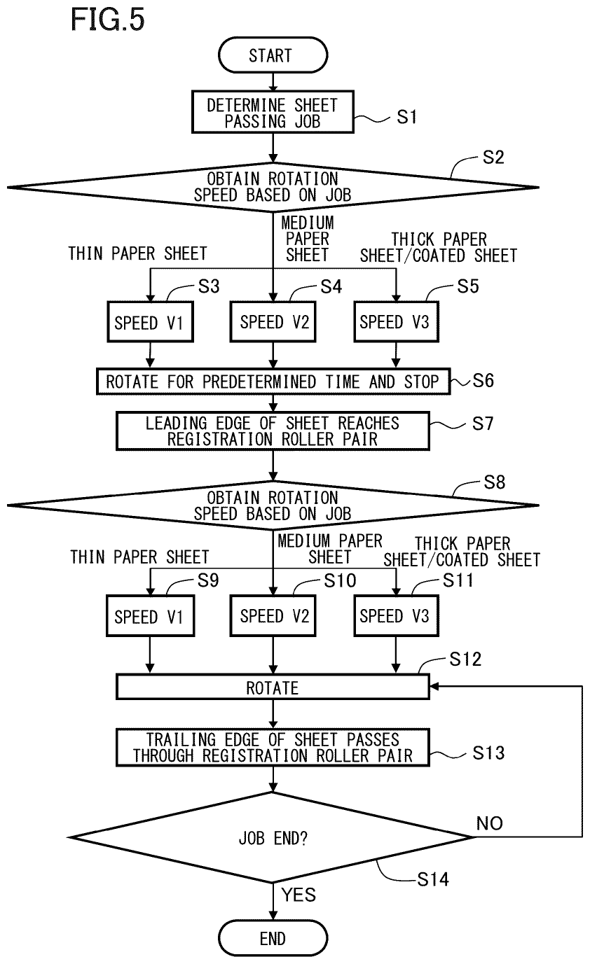

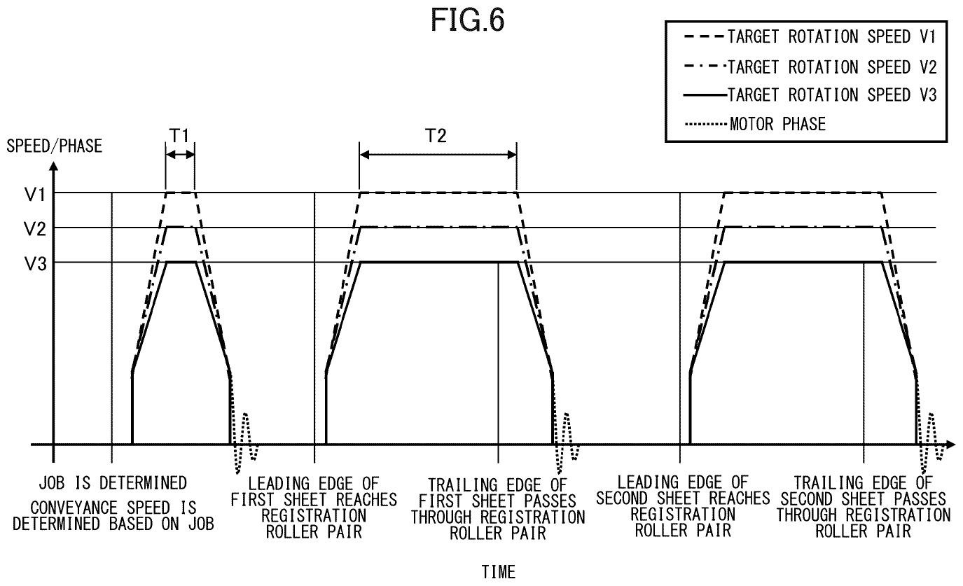

Hereinafter, a process of reducing backlash in the present embodiment will be described with reference to FIGS. 5 and 6. In the present embodiment, the image forming apparatus 1 performs the control for a slower image forming speed and a slower sheet conveyance speed for a sheet S, such as a thick paper sheet having a larger grammage or a coated sheet whose surface is coated, than those for a sheet S, such as a thin paper sheet having a smaller grammage or a non-coated sheet whose surface is not coated, for ensuring the fixability of toner. For example, when the registration driving motor 212 rotates the registration roller pair 20, the target rotation speed of the registration driving motor 212 is changed. For example, a target rotation speed V1 that is a high speed is set for a thin paper sheet, a target rotation speed V2 that is a medium speed slower than the high speed is set for a medium paper sheet, and a target rotation speed V3 that is a low speed slower than the medium speed is set for a thick paper sheet or a coated sheet. For example, in a case where the sheet information represents grammage, if the control portion 30 obtains a first grammage as the sheet information, the control portion 30 obtains the speed V1 (i.e., a first speed) as the target rotation speed. If the control portion 30 obtains, as the sheet information, a second grammage larger than the first grammage, the control portion 30 obtains the speed V2 (i.e., a second speed) slower than the speed V1 (i.e., a first speed), as the target rotation speed. That is, the control portion 30 selects a conveyance speed from among a plurality of conveyance speeds, in accordance with the type of the sheet S; and conveys the sheet S.

In addition, in the present embodiment, after an image forming job (e.g., a print image, and the type and the number of sheets S) is determined, the registration driving motor 212 is rotated for a predetermined time at a speed in accordance with the conveyance speed for the image forming job and then stopped before the first sheet S reaches the registration roller pair 20. With this operation, the above-described backlash between gears is reduced. That is, before abutting the sheet S against the registration roller pair 20, the control portion 30 performs the process of reducing backlash of the transmission mechanism 230 by driving the registration driving motor 212 and then stopping the registration driving motor 212. Note that in the present embodiment, the process of reducing backlash has only to be a process for reducing the backlash of at least the transmission mechanism 230. In addition to this, the process of reducing backlash may include a process of reducing backlash between the transmission mechanism 230 and the driving roller 21. In another case, the process of reducing backlash may include a process of reducing backlash in the registration driving motor 212.

In addition, in the present embodiment, in a case where the control portion 30 reduces the rotation speed of the registration driving motor 212 from a target rotation speed to stop the registration driving motor 212, in the process of reducing backlash, the control portion 30 reduces the rotation speed in two stages: a stage in which the rotation speed is reduced with a first deceleration gradient, and a stage in which the rotation speed is reduced more rapidly with a second deceleration gradient that is a steep gradient. The first deceleration gradient is a gradient with which the rotation speed is reduced from a target rotation speed to a threshold speed slower than the target rotation speed. The second deceleration gradient is a gradient with which the rotation speed is reduced from the threshold speed until the registration driving motor 212 is stopped.

Thus, in the process of reducing backlash, before performing the process of reducing backlash, the control portion 30 obtains a target rotation speed of the registration driving motor 212 at which the sheet S is conveyed by the registration roller pair 20 after the process of reducing backlash. In the execution of the process of reducing backlash, the control portion 30 accelerates the registration driving motor 212 to the target rotation speed, and subsequently reduces the rotation speed from the target rotation speed to stop the registration driving motor 212. In this case, the control portion 30 reduces the rotation speed from the target rotation speed to stop the registration driving motor 212 in the same manner as that after the sheet is conveyed by the registration roller pair 20 after the process of reducing backlash, the control portion 30 reduces the rotation speed from the target rotation speed to stop the registration driving motor 212. As a result, the state of backlash of the transmission mechanism 230 obtained immediately after the process of reducing backlash becomes equal to the state of backlash of the transmission mechanism 230 obtained when the registration roller pair 20 is stopped after the sheet S is actually conveyed after the process of reducing backlash. Thus, the difference between the state of backlash of the transmission mechanism 230 on which the process of reducing backlash has been performed and which is obtained before the conveyance of the first sheet is started, and the state of backlash of the transmission mechanism 230 which is obtained before the conveyance of each of the second and the following sheets is started can be reduced in an image forming job.

After that, the control portion 30 performs the control so that the leading edge of the sheet S is abutted against the registration roller pair 20 and the registration driving motor 212 starts to rotate in synchronization with a timing at which an image is formed. The control portion 30 stops the rotation of the registration driving motor 212 at a timing at which the trailing edge of the sheet S has passed through the registration roller pair 20. Each of the second and the following sheets is conveyed in the image forming job such that the leading edge of the sheet S is abutted against the registration roller pair 20 that is stopped, and a corresponding image is formed on the sheet in the same manner.

Next, a procedure for performing the process of reducing backlash in an image forming job will be described with reference to a flowchart illustrated in FIG. 5. If an image forming job (i.e., a sheet passing job) is determined (S1), then the control portion 30 obtains a target rotation speed of the registration driving motor 212 in accordance with the sheet information on the job (S2). For example, the control portion 30 obtains the target rotation speed V1 (S3), which is a high speed, if the sheet is a thin paper sheet; obtains the target rotation speed V2 (S4), which is a medium speed, if the sheet is a medium paper sheet; and obtains the target rotation speed V3 (S5), which is a low speed, if the sheet is a thick paper sheet or a coated sheet. For example, the control portion 30 obtains the target rotation speed, based on the sheet information, by referring to a table.

Then the control portion 30 drives and rotates the registration driving motor 212 in accordance with the obtained target rotation speed, and reduces the rotation speed after a predetermined time T1 to stop the registration driving motor 212. With this operation, the process of reducing backlash is completed. The predetermined time T1 is set shorter than a time (T2) in which the sheet S is conveyed at the target rotation speed after the process of reducing backlash. For example, the predetermined time T1 is in a range from about 0.1 to 0.5 seconds (see FIG. 6). That is, the control portion 30 sets the time in which the registration driving motor 212 is driven at the target rotation speed in the process of reducing backlash, shorter than the time in which the registration driving motor 212 is driven at the target rotation speed when the sheet S is conveyed by the registration roller pair 20 after the process of reducing backlash. Thus, the reduction in productivity can be prevented even if the process of reducing backlash is performed.

FIG. 6 is a time chart schematically illustrating command values for rotating the registration driving motor 212. The command values are illustrated for each target rotation speed. Note that there is a case where the actual rotation speed does not exactly correspond to a corresponding command value. Since FIG. 6 is a schematic diagram, the actual time chart differs from the time chart illustrated in FIG. 6. This is because if the size of the sheet S is constant, the time in which the sheet S has passed through the registration roller pair 20 varies if the target rotation speed is made different.

After the registration roller pair 20 is stopped in the process of reducing backlash, the control portion 30 causes the leading edge of the first sheet S to reach the registration roller pair 20 (S7). The control portion 30 obtains a target rotation speed of the registration driving motor 212 in accordance with the sheet information on the job (S8). For example, the control portion 30 obtains the target rotation speed V1 (S9), which is a high speed, if the sheet is a thin paper sheet; obtains the target rotation speed V2 (S10), which is a medium speed, if the sheet is a medium paper sheet; and obtains the target rotation speed V3 (S11), which is a low speed, if the sheet is a thick paper sheet or a coated sheet. The control portion 30 rotates the registration driving motor 212 in synchronization with an image forming timing (S12), and conveys the sheet S. If the control portion 30 determines that the trailing edge of the sheet S has passed through the registration roller pair 20 (S13), then the control portion 30 determines whether the image forming job is completed (S14). If the control portion 30 determines that the image forming job is not completed (S14: NO), then the control portion 30 conveys the next sheet S (S12). If the control portion 30 determines that the image forming job is completed (S14: YES), then the control portion 30 ends the process.

Since the control is performed in this manner, the rotation speed of the registration driving motor 212 obtained before the leading edge of the first sheet reaches the registration roller pair 20 in a job is made equal to the rotation speed of the registration driving motor 212 obtained before each of the second and the following sheets reaches the registration driving motor 212 in the job. As a result, the vibration of the registration driving motor 212 obtained when the registration driving motor 212 is stopped before the leading edge of the first sheet reaches the registration roller pair 20 in the job is made almost equal to the vibration of the registration driving motor 212 obtained when the registration driving motor 212 is stopped before each of the second and the following sheets reaches the registration driving motor 212 in the job (the vibration is indicated by a broken line in FIG. 6). Thus, the difference in the backlash in the transmission mechanism 230 and the difference in tension of the timing belt 232 are reduced, so that the time lag between the start of rotation of the registration driving motor 212 and the start of rotation of the driving roller 21 for the first sheet is made almost equal to the time lag between the start of rotation of the registration driving motor 212 and the start of rotation of the driving roller 21 for each of the second and the following sheets. As a result, the variations in the leading-edge registration value can be reduced.

In the present embodiment, in an image forming job, images are formed on a plurality of sheets S whose size and type are the same as each other. For this reason, after the start of the image forming job, it is not necessary to perform the process of reducing backlash. That is, in a case where a conveyance job is performed for conveying a plurality of sheets at a constant target rotation speed, the control portion 30 performs the process of reducing backlash before abutting the first sheet against the registration roller pair 20, and after that, the control portion 30 does not perform the process of reducing backlash until the conveyance job is completed. In contrast, in a case where a mixed-sheets job in which a plurality of types of sheets is used in a single image forming job is performed, the control portion 30 may perform the process of reducing backlash every time the conveyance speed is changed.

As described above, in the image forming apparatus 1 of the present embodiment, the control portion 30 reduces the rotation speed of the registration driving motor 212 from the target rotation speed to stop the registration driving motor 212 in the same manner as that after the sheet is conveyed by the registration roller pair 20 after the process of reducing backlash, the control portion 30 reduces the rotation speed of the registration driving motor 212 from the target rotation speed to stop the registration driving motor 212. As a result, the state of backlash of the transmission mechanism 230 obtained immediately after the process of reducing backlash becomes equal to the state of backlash of the transmission mechanism 230 obtained when the registration roller pair 20 is stopped after the sheet S is actually conveyed after the process of reducing backlash. Thus, the difference between the state of backlash of the transmission mechanism 230 on which the process of reducing backlash has been performed and which is obtained before the conveyance of the first sheet is started, and the state of backlash of the transmission mechanism 230 which is obtained before the conveyance of each of the second and the following sheets is started can be reduced in an image forming job. Thus, since the state of the drive train for the registration roller pair for the first sheet in a sheet passing job is made equal to the state of the drive train for each of the second and the following sheets in the sheet passing job, the variations in the leading-edge registration value can be reduced.

In the present embodiment, the transmission mechanism 230 includes the timing belt 232. Since the timing belt 232 is an elastic member, the backlash easily occurs in the timing belt 232 due to the expansion and contraction of the belt. In the present embodiment, however, even in such a case, the variations in backlash of the transmission mechanism 230 can be reduced.

In the above-described embodiment, the description has been mad for the case where the present disclosure is applied to the registration roller pair 20 that serves as a registration roller pair, and that conveys the sheet S to the secondary transfer portion 161. However, the present disclosure is not limited to this. For example, the present disclosure may be applied to the whole of registration roller pairs that convey the sheet S at a predetermined timing. For example, the present disclosure may also be applied to an image reading apparatus that reads the image of a sheet S.

### Second Embodiment

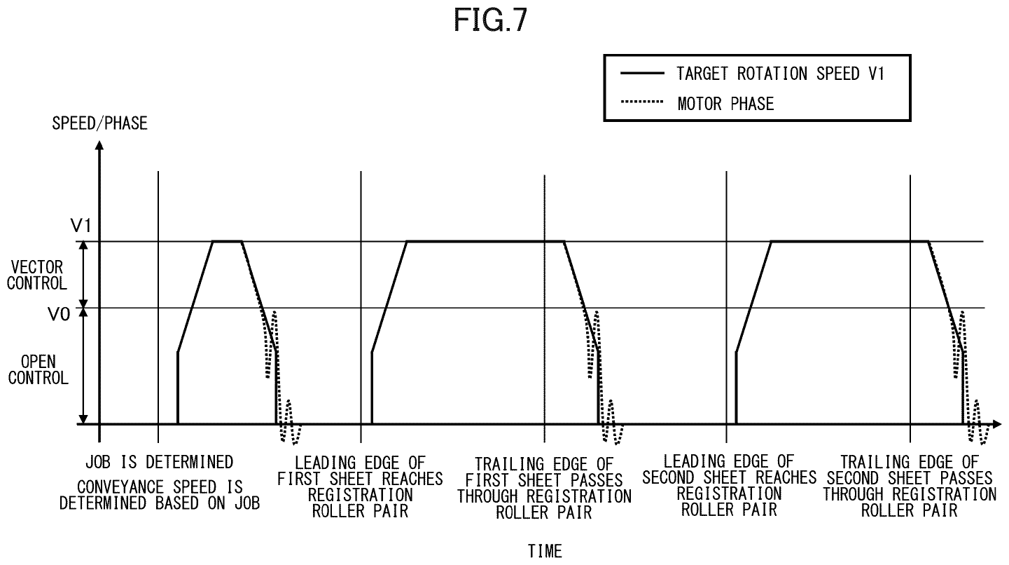

Next, a second embodiment of the present disclosure will be described in detail with reference to FIGS. 7 to 9. The present embodiment differs from the first embodiment in that the vector control and the open control are used for controlling the registration driving motor 212. Since the other configuration of the present embodiment is the same as that of the first embodiment, a component identical to a component of the first embodiment is given an identical symbol, and the detailed description thereof will be omitted.

In the present embodiment, as illustrated in FIG. 7, the control portion 30 performs the vector control and the open control in the process of reducing backlash. The control portion 30 rotates the registration driving motor 212 at a target rotation speed V1 by using the vector control that controls d-axis current and q-axis current. The control portion 30 uses the vector control for reducing the rotation speed from the target rotation speed to a threshold speed V0, and uses the open control for reducing the rotation speed from the threshold speed V0 until the registration driving motor 212 is stopped. The open control is the control that turns a constant supply current on and off.

In the present embodiment, the control of the registration driving motor 212 performed by the control portion 30 in a sheet passing operation is performed on a current component that generates torque, and on a current component that causes a rotor to generate magnetic flux. Thus, the control portion 30 performs so-called sensorless vector control that controls each current component independently. As a result, an optimized operation can be achieved in accordance with the rotation state of the registration driving motor 212, and the operating sound can be reduced effectively. However, since the induced voltage has a small value in a low-speed range in which the registration driving motor 212 is accelerated and decelerated, the open excitation control is required in the low-speed range. The open excitation control performs the synchronous driving by generating a rotating magnetic field by flowing a constant current. When the open excitation control performs the synchronous driving, vibration (shock) may be caused by a motor forced to be in phase. The vibration caused when the rotation speed is reduced may affect the leading-edge registration value. For this reason, the process of reducing backlash is performed, as in the first embodiment. Specifically, the registration driving motor 212 is rotated before the first sheet is conveyed in a sheet passing job at the same speed as the speed at which each of the second and the following sheets is conveyed. As a result, the vibration caused by changing of the control can be made equal. With this operation, the influence for the variations in the leading-edge registration value can be reduced.

### Details of Vector Control

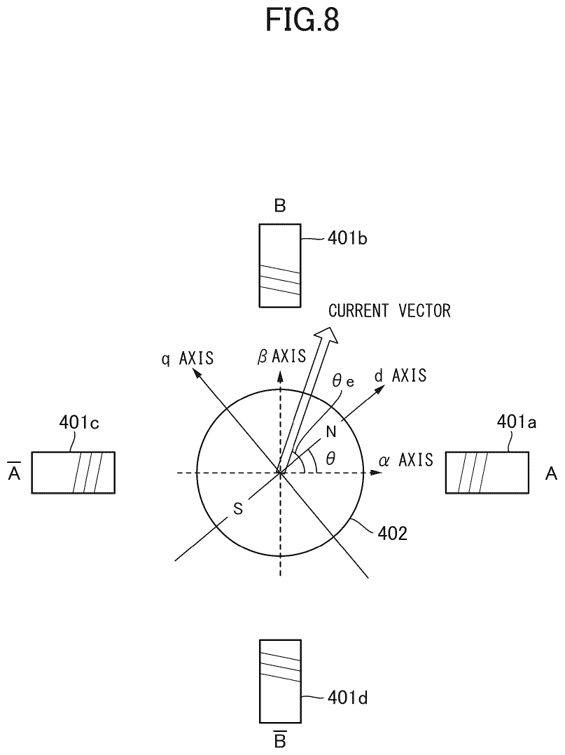

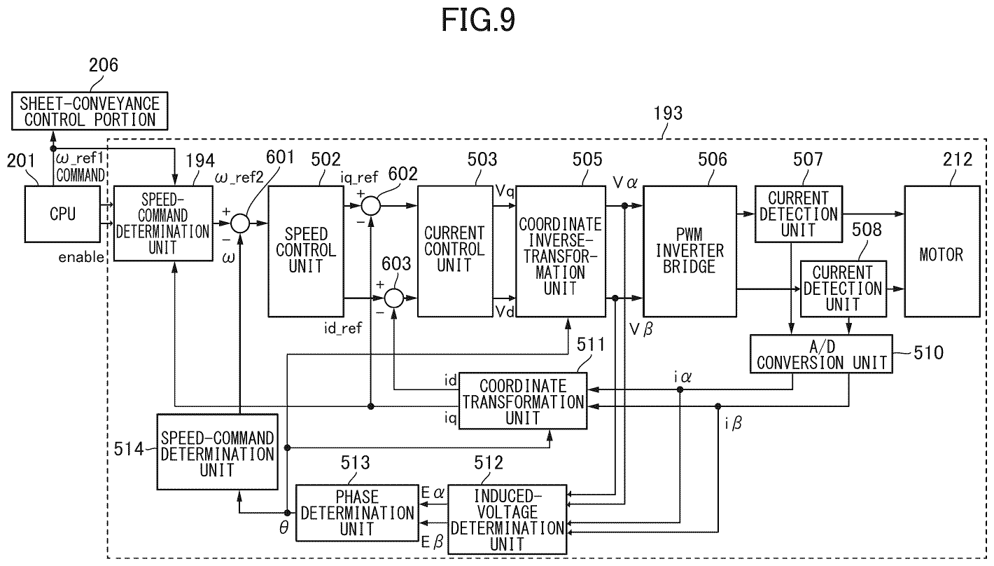

The control portion 30 includes a motor control portion 193 that performs the vector control. A functional configuration and general control (process) of the motor control portion 193 that controls the rotation speed and torque of the registration driving motor 212 will be described with reference to FIGS. 8 and 9. FIG. 8 is a diagram illustrating the vector control of the motor. FIG. 9 is a block diagram illustrating control functions of the motor control portion. Note that the technique of the motor control portion that performs the speed control, depending on the difference between the torque obtained when no sheet is conveyed and the torque obtained when a sheet is conveyed, is described in Japanese Patent Laid-Open No. 2019-151486.

### Vector Control

First, the vector control performed by the motor control portion will be described with reference to FIG. 8. The motor control portion 193 controls the registration driving motor 212 by using the vector control. Note that the below-described motor is provided with no sensor, such as a rotary encoder, that detects a rotation phase of the rotor of the motor. However, the motor may be provided with a sensor, such as a rotary encoder.

FIG. 8 is a diagram illustrating a relationship between the registration driving motor 212 and a rotating coordinate system. The registration driving motor 212 is a stepping motor that has two phases: an A phase (i.e., a first phase) and a B phase (i.e., a second phase). The rotating coordinate system is represented by a d axis and a q axis. In FIG. 8, an α axis that corresponds to a coil of the A phase and a B axis that corresponds to a coil of the B phase are defined. In addition, in FIG. 8, the d axis is defined so as to extend along the direction of the magnetic flux generated by the magnetic pole of the permanent magnet used in a rotor 402, and the q axis is defined so as to extend along the direction rotated 90 degrees counterclockwise from the d axis (i.e., the direction orthogonal to the d axis). The angle formed by the α axis and the d axis is defined as θ, and the rotation phase of the rotor 402 is denoted by θ. In the vector control, a rotating coordinate system in which the rotation phase θ of the rotor 402 serves as the reference is used. Specifically, in the vector control, a q-axis component (i.e., a torque-current component) and a d-axis component (i.e., an exciting-current component) are used. The q-axis component causes the rotor 402 to generate torque, and the d-axis component affects the intensity of magnetic flux that passes though the coils 401a to 401d. The torque-current component is a current component of a current vector in the rotating coordinate system. The current vector corresponds to the driving current that flows in the coils 401a to 401d. That is, the vector control is a method for controlling the motor by performing the speed feedback control that controls the torque-current component value and the exciting-current component value so that the difference between the commanded speed that represents the target speed of the rotor 402 and the actual speed decreases.

### Functional Configuration of Motor Control Portion

Next, a functional configuration of the motor control portion 193 that controls the registration driving motor 212 will be described with reference to FIG. 9. Note that the motor control portion 193 is constituted by at least one ASIC (application specific integrated circuit), and performs below-described functions.

The motor control portion 193 includes, as circuits that perform the vector control, a speed control unit 502, a current control unit 503, a coordinate inverse-transformation unit 505, a coordinate transformation unit 511, and a PWM inverter 506 that supplies driving current to the coils 401a to 401d of the motor.

The coordinate transformation unit 511 transforms the coordinate system of the current vector, which corresponds to the driving current that flows in the coils 401a to 401d (each having the A phase or the B phase) of the registration driving motor 212, from the static coordinate system represented by the α axis and the β axis, to the rotating coordinate system represented by the q axis and the d axis. As a result, the driving current that flows in the coils 401a to 401d is represented by a current value (i.e., a q-axis current) of the q-axis component and a current value (i.e., a d-axis current) of the d-axis component. The current value of the q-axis component and the current value of the d-axis component are current values in the rotating coordinate system. Note that the q-axis current corresponds to the torque current that causes the rotor 402 of the registration driving motor 212 to generate torque. In addition, the d-axis current corresponds to the exciting current that affects the intensity of magnetic flux that passes through the coils 401a to 401d of the registration driving motor 212, and does not contribute to the generation of torque of the rotor 402. The motor control portion 193 can control the q-axis current and the d-axis current independently. Thus, the motor control portion 193 can efficiently generate the torque necessary to rotate the rotor 402, by controlling the q-axis current in accordance with the load torque applied to the rotor 402. That is, in the vector control, the magnitude of the current vector illustrated in FIG. 8 changes in accordance with the load torque applied to the rotor 402.

The motor control portion 193 determines a rotation speed ω of the rotor 402 of the registration driving motor 212 by using a below-described method; and performs the vector control, based on the result of the determination. The CPU 201 outputs a command to a speed-command determination unit 194 for driving the registration driving motor 212. Note that the command outputted from the CPU 201 includes a commanded speed ω_ref1 that represents a target speed of the rotor 402 of the registration driving motor 212. Based on the commanded speed ω_ref1, the speed-command determination unit 194 generates a commanded speed ω_ref2 that represents a target speed of the rotor 402 of the registration driving motor 212, and outputs the commanded speed ω_ref2.

A subtraction unit 601 calculates the difference between a rotation speed ω of the rotor 402 of the registration driving motor 212 outputted from a speed-command determination unit 514 and the commanded speed ω_ref2, and outputs the difference.

The speed control unit 502 obtains the difference outputted from the subtraction unit 601 at intervals of T (e.g., 200 microseconds). Based on the proportional control (P), the integral control (I), and the derivative control (D), the speed control unit 502 generates a q-axis current command value iq_ref and a d-axis current command value id_ref so that the difference obtained from the subtraction unit 601 decreases, and outputs the q-axis current command value iq_ref and the d-axis current command value id_ref. Specifically, based on the P control, the I control, and the D control, the speed control unit 502 generates the q-axis current command value iq_ref and the d-axis current command value id_ref so that the difference obtained from the subtraction unit 601 becomes zero, and outputs the q-axis current command value iq_ref and the d-axis current command value id_ref. Note that the P control is a control method that controls the value of an object controlled by the method, based on a value that is proportional to the difference between a command value and an estimated value. The I control is a control method that controls the value of an object controlled by the method, based on a value that is proportional to a value obtained by integrating the difference between a command value and an estimated value, with respect to time. The D control is a control method that controls the value of an object controlled by the method, based on a value that is proportional to a change in the difference between a command value and an estimated value. The speed control unit 502 illustrated in FIG. 9 generates the q-axis current command value iq_ref and the d-axis current command value id_ref, by using the PID control. However, the present disclosure is not limited to this. For example, the speed control unit 502 may generate the q-axis current command value and the d-axis current command value by using the PI control. Note that in a case where a permanent magnet is used in the rotor 402, the d-axis current command value id_ref, which affects the intensity of magnetic flux that passes through the coils 401a to 401d, is commonly set at zero. However, the present disclosure is not limited to this.

The driving current that flows in the coils 401a to 401d, each having the A phase or the B phase, of the registration driving motor 212 is detected by current detection units 507 and 508, and then is converted from an analog value to a digital value by an A/D conversion unit 510. Note that the intervals at which the current detection units 507 and 508 detect the current are, for example, equal to or smaller than the intervals T at which the speed control unit 502 obtains the difference (for example, the intervals at which the current detection units 507 and 508 detect the current are 25 microseconds).

The current value of the driving current, converted from the analog value to the digital value by the A/D conversion unit 510, is expressed as current values iα and iβ in the static coordinate system, by using the following equations by using a phase Oe of the current vector illustrated in FIG. 8. Note that the phase θe of the current vector is defined as an angle formed by the α axis and the current vector. In addition, a parameter I represents the magnitude of the current vector.

$$i α = I \times cos θ e \qquad ( 1 )$$

$$i β = I \times sin θ e \qquad ( 2 )$$

The current values iα and iβ are sent to the coordinate transformation unit 511 and the induced-voltage determination unit 512.

The coordinate transformation unit 511 converts the current values ia and iβ in the static coordinate system, to a current value iq of the q-axis current and a current value id of the d-axis current in the rotating coordinate system by using the following equations.

$$id = cos θ \times i α + sin θ \times i β \qquad ( 3 )$$

$$iq = - sin θ \times i α + cos θ \times i β \qquad ( 4 )$$

The coordinate transformation unit 511 outputs the converted current value iq to a subtraction unit 602 and the speed-command determination unit 194. In addition, the coordinate transformation unit 511 outputs the converted current value id to a subtraction unit 603. The speed-command determination unit 194 will be described below.

The subtraction unit 602 calculates the difference between the q-axis current command value iq_ref and the current value iq, and outputs the difference to the current control unit 503. In addition, the subtraction unit 603 calculates the difference between the d-axis current command value id_ref and the current value id, and outputs the difference to the current control unit 503.

The current control unit 503 generates driving voltages Vq and Vd by using the PID control so that each of the difference outputted from the subtraction unit 602 and the difference outputted from the subtraction unit 603 decreases. Specifically, the current control unit 503 generates the driving voltages Vq and Vd so that each of the difference outputted from the subtraction unit 602 and the difference outputted from the subtraction unit 603 becomes zero; and outputs the driving voltages Vq and Vd to the coordinate inverse-transformation unit 505. That is, the current control unit 503 functions as a generation unit of the driving voltages Vq and Vd. Note that although the current control unit 503 illustrated in FIG. 9 generates the driving voltages Vq and Vd by using the PID control, the present disclosure is not limited to this. For example, the current control unit 503 may generate the driving voltages Vq and Vd by using the PI control.

The coordinate inverse-transformation unit 505 inverse-transforms the driving voltages Vq and Vd outputted from the current control unit 503 and obtained in the rotating coordinate system, to driving voltages Vα and Vβ obtained in the static coordinate system by using the following equations.

$$V α = cos θ \times Vd - sin θ \times Vq \qquad ( 5 )$$

$$V β = sin θ \times V d + cos θ \times Vq \qquad ( 6 )$$

The coordinate inverse-transformation unit 505 outputs the inverse-transformed driving voltages Vα and Vβ, to the induced-voltage determination unit 512 and the PWM inverter 506.

The PWM inverter 506 includes a full-bridge circuit. The full-bridge circuit is driven by pulse width modulation (PWM) signals based on the driving voltages Vα and Vβ sent from the coordinate inverse-transformation unit 505. As a result, the PWM inverter 506 generates driving currents ia and iβ in accordance with the driving voltages Vα and Vβ, and drives the registration driving motor 212 by supplying the driving currents ia and iβ to the coils 401a to 401d, each having a corresponding phase, of the registration driving motor 212. That is, the PWM inverter 506 functions as a supply unit that supplies current to the coils 401a to 401d, each having a corresponding phase, of the registration driving motor 212. Note that although the PWM inverter 506 illustrated in FIG. 9 includes a full-bridge circuit, the PWM inverter 506 may include a half-bridge circuit.

Next, a method of determining the rotation phase θ will be described. For determining the rotation phase θ of the rotor 402, induced voltages Eα and Eβ are used. The induced voltages Eα and Eβ are induced in the coils 401a to 401d, each having the phase A or the phase B, of the registration driving motor 212. The values of the induced voltages Eα and Eβ are determined (calculated) by the induced-voltage determination unit 512. Specifically, the induced voltages Eα and Eβ are determined from the current values ia and iβ sent from the A/D conversion unit 510 to the induced-voltage determination unit 512 and the driving voltages Vα and Vβ sent from the coordinate inverse-transformation unit 505 to the induced-voltage determination unit 512, by using the following equations.

$$E α = V α - R \times i α - L \times di α / dt \qquad ( 7 )$$

$$E β = V β - R \times i β - L \times di β / dt \qquad ( 8 )$$

In the equations (7) and (8), a parameter R represents a coil resistance, and a parameter L represents a coil inductance. Each of the coil resistance R and the coil inductance L is an intrinsic value of the registration driving motor 212 that is used, and stored in advance in the ROM or a memory (not illustrated) disposed in the motor control portion 193. The induced voltages Eα and Eβ determined by the induced-voltage determination unit 512 are outputted to a phase determination unit 513.

The phase determination unit 513 determines the rotation phase θ of the rotor 402 of the registration driving motor 212 by using the following equation, based on the ratio between the induced voltages Eα and Eβ outputted from the induced-voltage determination unit 512.

$$θ = {tan}^{∧} - 1 ( - E β / B α ) \qquad ( 9 )$$

Note that although the phase determination unit 513 illustrated in FIG. 9 determines the rotation phase θ by performing the calculation by using the equation (9), the present disclosure is not limited to this. For example, the phase determination unit 513 may determine the rotation phase θ by referring to a table stored in the ROM or the like and indicating the relationship between the induced voltages Ex and Eβ and the rotation phase θ that corresponds to the induced voltages Eα and Eβ. The rotation phase θ of the rotor 402 obtained in the above-described manner is sent to the coordinate inverse-transformation unit 505, the coordinate transformation unit 511, and the speed-command determination unit 514.

The speed-command determination unit 514 determines the rotation speed ω of the rotor 402, based on the amount of change of the rotation phase θ sent from the phase determination unit 513 in a predetermined period of time. Specifically, the speed-command determination unit 514 determines the rotation speed ω of the rotor 402 by using the following equation (10).

$$ω = d θ / dt \qquad ( 10 )$$

The rotation speed ω of the rotor 402 obtained in the above-described manner is sent to the subtraction unit 601.

As described above, the motor control portion 193 repeats the above-described function (control), and thereby performs the vector control, which controls the current value in the rotating coordinate system, so that the difference between the commanded speed ω_ref2 and the rotation speed ω decreases. The vector control can suppress the motor from losing synchronization, and the motor sound from increasing due to surplus torque. In addition, the vector control can suppress the increase in power consumption.

As described above, in the image forming apparatus 1 of the present embodiment, the control portion 30 reduces the rotation speed of the registration driving motor 212 from the target rotation speed to stop the registration driving motor 212 in the same manner as that after the sheet is conveyed by the registration roller pair 20 after the process of reducing backlash, the control portion 30 reduces the rotation speed of the registration driving motor 212 from the target rotation speed to stop the registration driving motor 212. As a result, the state of backlash of the transmission mechanism 230 obtained immediately after the process of reducing backlash becomes equal to the state of backlash of the transmission mechanism 230 obtained when the registration roller pair 20 is stopped after the sheet S is actually conveyed after the process of reducing backlash. Thus, the difference between the state of backlash of the transmission mechanism 230 on which the process of reducing backlash has been performed and which is obtained before the conveyance of the first sheet is started, and the state of backlash of the transmission mechanism 230 which is obtained before the conveyance of each of the second and the following sheets is started can be reduced in an image forming job. Thus, since the state of the drive train for the registration roller pair for the first sheet in a sheet passing job is made equal to the state of the drive train for each of the second and the following sheets in the sheet passing job, the variations in the leading-edge registration value can be reduced.

The present disclosure can reduce the difference between the state of backlash of the drive train on which the process of reducing backlash has been performed and which is obtained before the conveyance of the first sheet is started in a conveyance job for conveying sheets, and the state of backlash of the drive train which is obtained before the conveyance of each of the second and the following sheets is started in the conveyance job.

### OTHER EMBODIMENTS

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-096541, filed Jun. 14, 2024 which is hereby incorporated by reference herein in its entirety.

What is claimed is:

1. A sheet conveyance apparatus comprising:
a registration roller pair including a first roller and a second roller configured to contact each other and form a nip portion, the registration roller pair being configured to convey a sheet by rotating after the sheet is abutted against the registration roller pair in a state where the registration roller pair is stopped;
a driving motor configured to rotationally drive the first roller;
a transmission mechanism including an endless member and configured to transmit power of the driving motor to the first roller via the endless member; and
a control portion configured to perform a process of reducing backlash of the transmission mechanism by driving and stopping the driving motor before abutting the sheet against the registration roller pair,
wherein the control portion is configured to obtain, before performing the process of reducing backlash, a target rotation speed of the driving motor at which the sheet is conveyed by the registration roller pair after the process of reducing backlash, and
wherein, in the process of reducing backlash, the control portion is configured to accelerate the driving motor to the target rotation speed and subsequently reduce rotation speed of the driving motor from the target rotation speed to stop the driving motor in a same manner as that after the sheet is conveyed by the registration roller pair after the process of reducing backlash, the control portion reduces the rotation speed of the driving motor from the target rotation speed to stop the driving motor.

2. The sheet conveyance apparatus according to claim 1, wherein in a case where the control portion reduces the rotation speed of the driving motor from the target rotation speed to stop the driving motor in the process of reducing backlash, the control portion is configured to
reduce the rotation speed with a first deceleration gradient from the target rotation speed to a threshold speed slower than the target rotation speed, and
reduce the rotation speed with a second deceleration gradient from the threshold speed to stop the driving motor, the rotation speed of the driving motor being reduced rapidly with the second deceleration gradient than with the first deceleration gradient.

3. The sheet conveyance apparatus according to claim 2, wherein in the process of reducing backlash, the control portion is configured to
rotate the driving motor at the target rotation speed by controlling the driving motor by using vector control that controls d-axis current and q-axis current,
reduce the rotation speed by using the vector control from the target rotation speed to the threshold speed, and
reduce the rotation speed by using open control from the threshold speed to stop the driving motor, the open control being control that turns constant current supply on and off.

4. The sheet conveyance apparatus according to claim 1, wherein the control portion is configured to set time in which the driving motor is driven at the target rotation speed in the process of reducing backlash, shorter than time in which the driving motor is driven at the target rotation speed in a case where the sheet is conveyed by the registration roller pair after the process of reducing backlash.

5. The sheet conveyance apparatus according to claim 1, wherein before performing the process of reducing backlash, the control portion is configured to
obtain sheet information on a sheet on which an image is to be formed after the process of reducing backlash, and
obtain the target rotation speed based on the sheet information.

6. The sheet conveyance apparatus according to claim 5,
wherein the sheet information is a grammage of the sheet, and
wherein the control portion is configured to
obtain a first speed as the target rotation speed in a case where the control portion obtains a first grammage as the sheet information, and
obtain a second speed, as the target rotation speed, slower the first speed in a case where the control portion obtains a second grammage, as the sheet information, larger than the first grammage.

7. The sheet conveyance apparatus according to claim 1, wherein in a case where the control portion performs a conveyance job in which a plurality of sheets is conveyed at the target rotation speed that is constant, the control portion is configured to perform the process of reducing backlash before abutting a first sheet against the registration roller pair, and after performing the process of reducing backlash, the control portion is configured not to perform the process of reducing backlash until the conveyance job is completed.

8. The sheet conveyance apparatus according to claim 1, wherein the endless member is a toothed belt made of an elastic material.

9. The sheet conveyance apparatus according to claim 1, further comprising:
a fixed-side unit supporting the second roller, the driving motor, and the transmission mechanism; and
an opened-and-closed-side unit supporting the first roller, and configured to open and close the fixed-side unit,
wherein in a state where the fixed-side unit is closed by the opened-and-closed-side unit, the first roller and the second roller are configured to be in contact with each other, and the first roller and the transmission mechanism are configured to be connected to each other, and
wherein in a state where the fixed-side unit is opened by the opened-and-closed-side unit, the first roller and the second roller are configured to be separated from each other, and the first roller and the transmission mechanism are configured to be disconnected from each other.

10. An image forming apparatus comprising:
the sheet conveyance apparatus according to claim 1; and
an image forming unit configured to form an image on a sheet at an image forming position,
wherein the control portion is configured to control the driving motor such that the sheet is abutted against the registration roller pair in a state where the registration roller pair is stopped, and subsequently conveyed to the image forming position at an image forming timing.
